(19) United States
(12) Patent Application Publication
(10) Pub. No.: US 2025/0309283 A1
(43) Pub. Date: Oct. 2, 2025

(54) FUEL CELL STRUCTURE

(71) Applicant: HONDA MOTOR CO., LTD., Tokyo (JP)

(72) Inventors: Suguru OMORI, Wako-shi (JP); Shun HATTORI, Wako-shi (JP)

(21) Appl. No.: 19/063,833

(22) Filed: Feb. 26, 2025

(30) Foreign Application Priority Data
Mar. 29, 2024 (JP) 2024-057600

(51) Int. Cl. H01M 8/0258; H01M 8/0273

(52) U.S. Cl. CPC H01M 8/0258; H01M 8/0273

(57) ABSTRACT

A fuel cell structure includes a tunnel portion which is formed in the separator, bypasses the seal portion, and allows the communication hole and the fluid channel to communicate with each other. The tunnel portion includes tunnel bodies extending from the communication hole toward the fluid channel, a joint channel which joins ends of the tunnel bodies together so as to allow for fluid communication through the ends, and openings which allow the joint channel and the fluid channel to communicate with each other. The tunnel bodies include an end tunnel body connected to an end of the joint channel. The end tunnel body is connected to the joint channel at an acute angle and a connection portion between the joint channel and the end tunnel body is curved in an arc.

### CROSS REFERENCE TO RELATED APPLICATIONS

This application claims the foreign priority benefit under 35 U.S.C. § 119 of Japanese patent application No. 2024-057600, filed on Mar. 29, 2024, the disclosure of which is incorporated herein by reference.

### BACKGROUND OF THE INVENTION

### 1. Field of the Invention

The present invention relates to a fuel cell structure.

### 2. Description of the Related Art

A conventional fuel cell structure has anode exhaust communication holes that communicate with a horizontal end of a fuel fluid channel on one side and discharge a fuel fluid in a stacking direction of a membrane electrode structure and separators. The fuel cell structure also has cathode exhaust communication holes that communicate with a horizontal end of an oxidant fluid channel on the other side and discharge an oxidant fluid in the stacking direction. In this type of fuel cell structure, the bottom of the lowest one of the cathode exhaust communication holes is located at a level lower than the bottom of the lowest one of the anode exhaust communication holes (see, for example, JP2022-71445A).

### CITATION LIST

### Patent Literature

PTL 1: JP2022-71445A

### SUMMARY OF THE INVENTION

In each of the separators, tunnels are formed through each of which the fluid channel and the communication hole communicate with each other while bypassing a seal member which seals the fluid channel and the communication hole. Due to a constraint on the positional relationship between the anode exhaust communication holes and the cathode exhaust communication holes, the conventional fuel cell structure has a problem of also inevitably having a constraint on the positions of the tunnels formed. In addition, the positions of the tunnels formed also affect the flows of the fluids within the tunnels, which makes it difficult to prevent generated water from stagnating and flowing backward. If the positional relationship between the anode exhaust communication holes and the cathode exhaust communication holes is prioritized as described above, there is a risk of having no way to prevent backflows of stagnant water. For this reason, there is a demand for further improvement.

The present disclosure has an object to provide a fuel cell structure capable of preventing backflows of stagnant water with a simple structure.

### SUMMARY OF THE INVENTION

To achieve the above issue, a fuel cell structure includes a membrane electrode structure including a membrane electrode assembly and a frame member surrounding the membrane electrode assembly, and a separator disposed between membrane electrode structures. The membrane electrode structures and separators are alternately stacked. The frame member and the separator define a communication hole which extends through the frame member and the separator in a stacking direction, allows the frame member and the separator to communicate with each other, and allows a power generation material fluid to flow through the communication hole. The fuel cell structure has a fluid channel which is provided between the membrane electrode structure and the separator and allows the power generation fluid to be supplied to the membrane electrode structure through the fluid channel. The fuel cell structure includes a seal portion which is provided around the communication hole and seals between the communication hole and the fluid channel.

The fuel cell structure includes a tunnel portion which is formed in the separator, bypasses the seal portion, and allows the communication hole and the fluid channel to communicate with each other. The tunnel portion includes tunnel bodies extending from the communication hole toward the fluid channel, a joint channel which joins ends of the tunnel bodies together so as to allow for fluid communication through the ends, and openings which allow the joint channel and the fluid channel to communicate with each other. The tunnel bodies include an end tunnel body connected to an end of the joint channel. The end tunnel body is connected to the joint channel at an acute angle and a connection portion between the joint channel and the end tunnel body is curved in an arc.

According to the present invention, provided is a fuel cell structure capable of preventing backflows of stagnant water with a simple structure.

### BRIEF DESCRIPTION OF THE DRAWINGS

FIG. 1 is a plan view of a separator in a fuel cell structure in an embodiment, showing a portion where a fluid channel and a communication hole communicate with each other through tunnel portions.

FIG. 2 is a plan view for explaining main constituent elements in the fuel cell structure in the embodiment.

FIG. 3 is a cross-sectional view taken along a III-III line in FIG. 2, for explaining main constituent elements in the fuel cell structure in the embodiment.

FIG. 4 is a plan view of the separator in the fuel cell structure in the embodiment for explaining an overall structure.

### DETAILED DESCRIPTION OF THE EMBODIMENTS

Hereinafter, an embodiment of a fuel cell structure of the present invention will be described by using the drawings as needed. In the following description, the same constituent elements will be given the same reference signs, and the repetitive description thereof will be omitted.

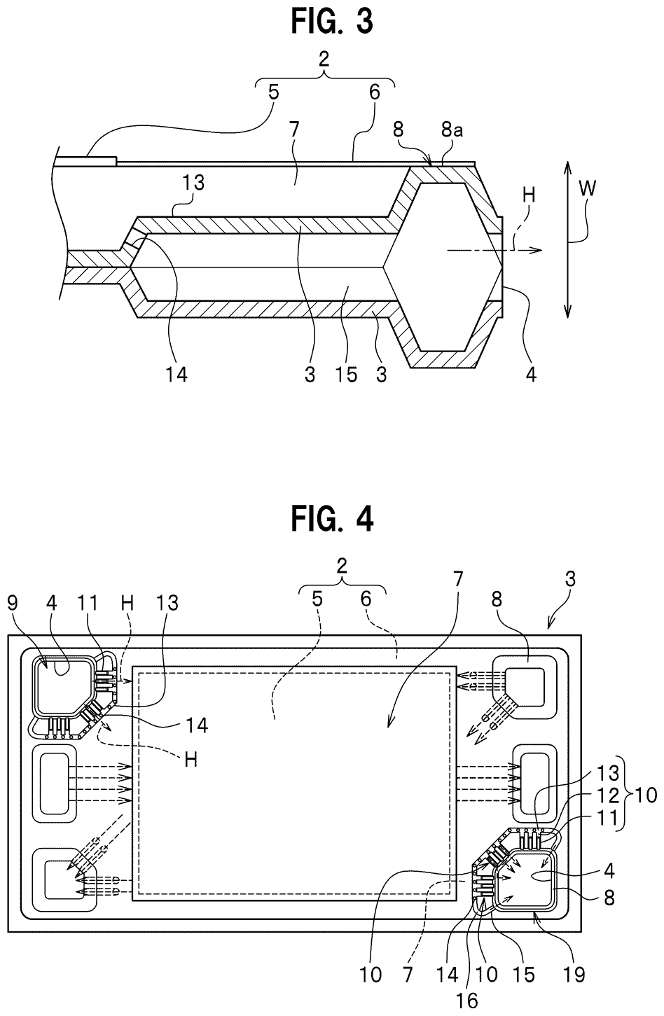

In the fuel cell structure in the embodiment, a multilayer cell stack in which unit cells 1 each having separators 3 and a membrane electrode structure 2 (see FIG. 3) are stacked in a stacking direction W is housed inside a cell case. In each unit cell 1, the membrane electrode structure 2 and the separators 3 which are arranged on both sides of the membrane electrode structure 2 and each of which is disposed between the membrane electrode structures 2 are stacked alternately.

Among them, the membrane electrode structure 2 has a membrane electrode assembly 5 forming an active region, and a frame member 6 surrounding the membrane electrode assembly 5. In the frame member 6 and each of the separators 3, communication holes 4 are formed which pass through them in the stacking direction W and communicate with each other, allowing a power generation material fluid (hereinafter also referred to as the fluid) H to flow therethrough.

As shown in FIG. 4, the multilayer cell stack is provided with a fluid supply manifold 9 through which the power generation material fluid H is distributed and supplied to fluid channels 7. The multilayer cell stack is also provided with a fluid exhaust manifold 19 through which the power generation material fluid H flowing down from the fluid channels 7 is collected and discharged. Each of the fluid supply manifold 9 and the fluid exhaust manifold 19 is structured with the communication holes 4 formed in the frame members 6 and the separators 3 communicating with each other in the stacking direction W. In the embodiment, the structure of the fluid exhaust manifold 19 will be mainly described while the description of the fluid supply manifold 9 having the same structure will be partly omitted.

The fluid channel 7 is provided between the membrane electrode structure 2 and each of the separators 3 through which a fluid to serve as a power generation material is supplied to the membrane electrode assembly 5. Different types of fluids, for example, power generation fluids H such as hydrogen and oxygen, are supplied to the fluid channels 7 arranged on both sides of the membrane electrode structure 2 and then supplied between the active regions of the membrane electrode assemblies 5, where power generation is performed.

A seal portion 8 is provided around a communication hole 4 formed in the fluid exhaust manifold 19 and seals between the communication hole 4 and the fluid channel 7. As shown in FIG. 3, the seal portion 8 is structured with the frame member 6 of the membrane electrode structure 2 brought into pressure contact with a protrusion 8a formed in the separator 3.

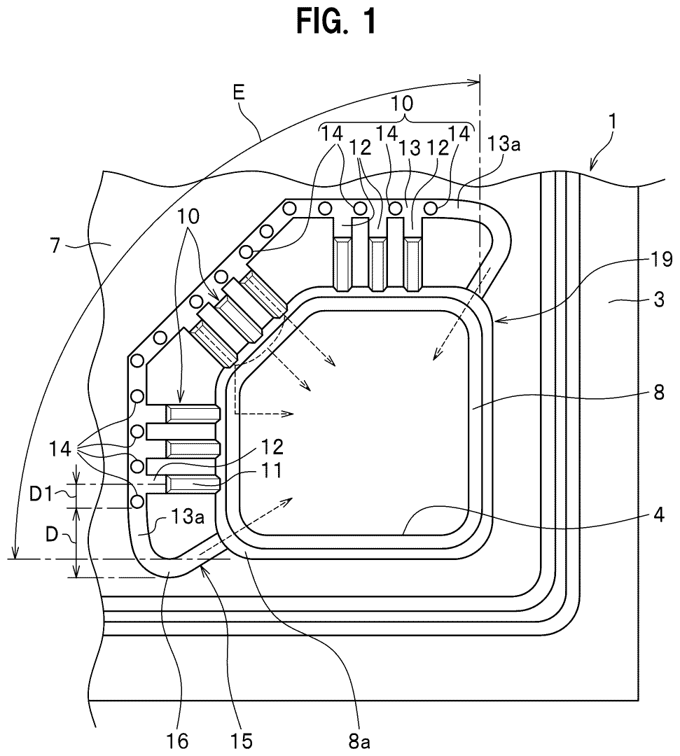

In the separator 3, tunnel portions 10 are formed which allow the communication hole 4 and the fluid channel 7 to communicate with each other while bypassing the seal portion 8. Each tunnel portion 10 in the embodiment is formed of groove portions recessed on the surface of the separator 3 opposite to the membrane electrode structure 2. The tunnel portion 10 includes tunnel bodies 11 extended from the communication hole 4 toward the fluid channel 7 as shown in FIG. 1.

Each tunnel body 11 is provided to extend in a direction orthogonal to the protrusion 8a formed in the separator 3, and is configured to bypass the seal portion 8 while crossing the seal portion 8 in the stacking direction W. Although FIG. 3 shows an end tunnel body 15, the other tunnel bodies 11 are also each configured to bypass the seal portion 8 while crossing the seal portion 8 in the stacking direction W in the same manner.

The tunnel portion 10 includes a joint channel 13 which joins ends 12 of the tunnel bodies 11 together so as to allow for fluid communication through the ends. The joint channel 13 in the embodiment is formed of a groove recessed on the surface of the separator 3 opposite to the membrane electrode structure 2.

The joint channel 13 in the embodiment is located at a predetermined distance away from and along the periphery of the communication hole 4 and is extended over the entire length of a range E where the communication hole 4 and the fluid channel 7 are adjacent to each other.

The tunnel portion 10 includes openings 14 through which the joint channel 13 and the fluid channel 7 communicate with each other. Each opening 14 in the embodiment is formed by drilling a side surface of the joint channel 13 on the membrane electrode assembly 5 side.

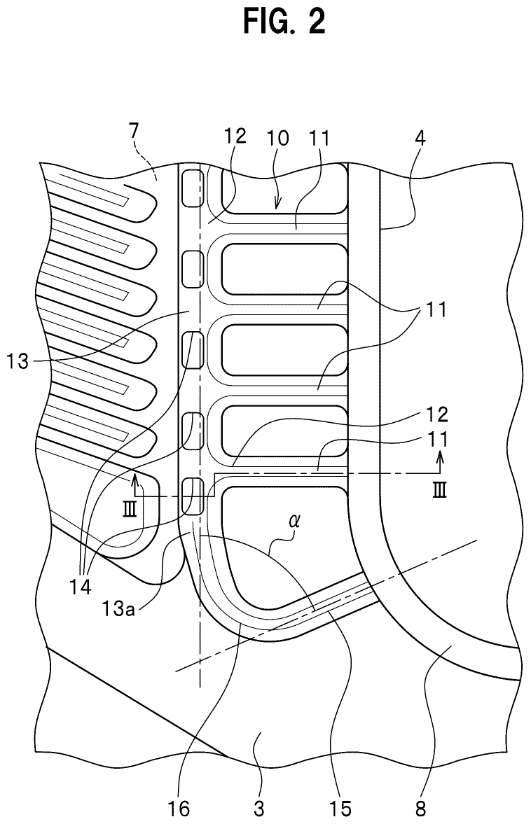

As shown in FIG. 2, in the fuel cell structure in the embodiment, among the tunnel bodies 11, the end tunnel body 15 is provided at an end of the joint channel 13. The end tunnel body 15 is joined to an end 13a of the joint channel 13 via a connection portion 16.

The end tunnel body 15 is connected to the joint channel 13 at an acute angle α. The connection portion 16 between the joint channel 13 and the end tunnel body 15 is formed curved in an arc.

In the embodiment, as shown in FIG. 1, the connection portion 16 of the end tunnel body 15 is provided at a position away from the opening 14 at the end 13a by a predetermined dimension D.

Specifically, the connection portion 16 in the embodiment is set such that the opening 14 closest to the connection portion 16 among the openings 14 is provided at a position away from the connection portion 16. To put it differently, none of the openings 14 is provided to the curved connection portion 16.

For example, the connection portion 16 in the embodiment is set such that the dimension D from the opening 14 to the connection portion 16 is larger than a dimension D1 from the opening 14 to the end 12 of the closest tunnel body 11 (D>D1).

In the fuel cell structure constituted as above in the embodiment, the fluid supply manifold 9 shown in FIG. 4 connects the fluid channel 7 sides of the tunnel bodies 11 to the joint channel 13. For this reason, the power generation material fluid H supplied into the fuel cell is distributed and supplied from the joint channel 13 through the openings 14 to the fluid channel 7.

In the fluid supply manifold 9, the openings 14 are formed in the joint channel 13. Therefore, compared to when there is only one opening 14 or when one opening 14 is provided for each tunnel body 11, it is possible to improve power generation efficiency by reducing a pressure drop.

In the embodiment, the joint channel 13 is extended over the entire length of the range E where the communication hole 4 and the fluid channel 7 are adjacent to each other. Therefore, many openings 14 can be provided to the joint channel 13 over the relatively long range E covering the three fluid channel 7 sides, which makes it possible to further improve the power generation efficiency by reducing the pressure drop.

In the embodiment, each opening 14 is offset from any of the ends 12 of the tunnel bodies 11 so as not to face the ends 12. For example, as shown in FIG. 1, when the number of the openings 14 formed is larger by one than the number of the ends, the total opening area of the openings 14 is increased. This makes it possible to diffuse the power generation material fluid H supplied from the ends 12, thereby further reducing the pressure drop.

Here, the openings 14 may be set as needed in terms of the opening diameter, the opening position, and the number of openings. In this way, the power generation efficiency can be improved by adapting the openings 14 depending on the size and shape of the fluid channel 7 or the active region. For example, while the power generation material fluids H such as hydrogen and oxygen are passing through the fluid channels 7 on both sides of the membrane electrode structure 2, the power is generated through reaction in the membrane electrode assembly 5. Then, water is generated along with the power generation in the membrane electrode assembly 5 and flows down along the fluid channel 7.

On the other hand, the fluid exhaust manifold 19 formed in the separator 3 has a function of collecting the water generated in the active region within the fuel cell through the tunnel portions 10 and discharging the generated water. However, there are cases where the generated water that fails to be completely discharged remains inside the tunnel bodies 11. The generated water once discharged to the communication holes 4 may stagnate in an area where the separators 3 are stacked, and act as stagnant water in contact with the metallic separators 3 for a long period of time.

If a running vehicle in the above state stops or stops in an inclined posture, the stagnant water on the separator 3 side will come into contact with the generated water on the active region side, for example, particularly in the lowermost end tunnel body 15 joined to the end 13a of the joint channel 13, so that these two liquids may merge.

When the liquids merge, there is a possibility that a metal component such as iron eluted from the separators 3 enter the active region together with the stagnant water, and deteriorate the membrane electrode assembly 5 in the membrane electrode structure 2.

To avoid this, the fuel cell structure in the embodiment of the present disclosure, the end tunnel body 15 among the tunnel bodies 11 is connected to the end 13a of the joint channel 13 via the connection portion 16 curved in the arc. Thus, the generated water which is to flow down into the end tunnel body 15 via the openings 14 from the fluid channel 7 smoothly flows along the arc-shaped connection portion 16 without stagnating inside the joint channel 13. Thus, the generated water is discharged in the direction toward the communication hole 4 with little resistance.

Moreover, the end tunnel body 15 is connected to the joint channel 13 at the acute angle α via the connection portion 16 arranged efficiently in a space between an outer peripheral corner portion of the communication hole 4 and the fluid channel 7. The openings 14 in the embodiment are provided at the positions away from the connection portion 16 of the end tunnel body 15 by the predetermined dimension D. Thus, none of the openings 14 is provided near the connection portion 16 of the end tunnel body 15. Regarding the openings 14, a distance to the opening 14 located above and closest to the connection portion 16 is longer than a distance that would be obtained if the end tunnel body 15 were directly and linearly connected to the joint channel 13 without the connection portion 16 provided in between.

Therefore, even if the generated water fails to be discharged completely from the end tunnel body 15, the water is less likely to flow backward toward the opening 14 above and closest to the connection portion 16. The closest opening 14 is located above the connection portion 16. Therefore, the generated water remaining in the end tunnel body 15 is discharged in the direction toward the communication hole 4 together with the generated water successively flowing from the openings 14. The position of the opening 14 arranged above and closest to the connection portion 16 is higher than the position where the end tunnel body 15 continued from the connection portion 16 crosses the seal portion 8. For this reason, the generated water inside the connection portion 16 tends to be discharged in the direction toward the communication hole 4.

Thus, the generated water flowing down into the tunnel bodies 11 and the end tunnel body 15 of the tunnel portion 10 is discharged without stagnating inside the joint channel 13. This reduces a risk of a liquid merge of the stagnant water on the separator 3 side and the generated water on the active region side. Accordingly, the fuel cell structure in the embodiment exerts a practically beneficial effect of preventing a deterioration of the membrane electrode assembly 5 provided in the membrane electrode structure 2.

As described above, in the present disclosure, the membrane electrode structure 2 including the membrane electrode assembly 5 and the frame member 6 surrounding the membrane electrode assembly 5 and the separators 3 each disposed between the membrane electrode structures 2 are alternately stacked. In the frame member 6 and each of the separators 3, the communication holes 4 are formed which pass through them in the stacking direction W and communicate with each other to allow the power generation material fluid H to flow therethrough. The fluid channel 7 through which the power generation material fluid H is supplied to the membrane electrode assembly 5 is provided between the membrane electrode structure 2 and each of the separators 3. The seal portion 8 is provided around the communication hole 4 and seals between the communication hole 4 and the fluid channel 7.

In each of the separators 3, the tunnel portions 10 are formed which allow the communication hole 4 and the fluid channel 7 communicate with each other while bypassing the seal portion 8. The tunnel portion 10 includes the tunnel bodies 11 extended from the communication hole 4 toward the fluid channel 7 and the joint channel 13 which joins the ends 12 of the tunnel bodies 11 together so as to allow for fluid communication through the ends. In addition, the tunnel portion 10 includes the openings 14 through which the joint channel 13 and the fluid channel 7 communicate with each other. Among the tunnel bodies 11, the end tunnel body 15 joined to the end 13a of the joint channel 13 is connected to the joint channel 13 at the acute angle. The connection portion 16 between the joint channel 13 and the end tunnel body 15 is curved in the arc.

In this way, the fuel cell structure in the present disclosure is capable of preventing backflows of the stagnant water with the simple structure.

That is, the end tunnel body 15 is capable of smoothly discharging the generated water flowing down from the connection portion 16, thereby preventing backflows of the generated water.

The joint channel 13 is extended over the entire length of the range E where the communication hole 4 and the fluid channel 7 are adjacent to each other.

This structure allows many openings 14 to be provided to the joint channel 13 and accordingly makes it possible to further improve the power generation efficiency by reducing the pressure drop.

The openings 14 are positioned apart from the connection portion 16 of the end tunnel body 15.

This makes it possible to make the distance to the closest opening 14 longer than the distance that would be obtained if the end tunnel body 15 were connected orthogonality to the joint channel 13 like the other tunnel bodies 11.

Accordingly, the generated water is more unlikely to flow backward to the openings 14. This reduces a risk of a liquid merge of the stagnant water on the separator 3 side and the generated water on the active region side. Therefore, the fuel cell structure exerts the practically beneficial effect of preventing a deterioration of the membrane electrode assembly 5 provided in the membrane electrode structure 2.

The present invention should not be limited to the aforementioned embodiment, but may be modified in various ways. The foregoing embodiment is described merely as an example for facilitating understanding of the present invention, and the present invention should not be limited to those including all the described constituent elements. Moreover, some of constituent elements in a certain embodiment may be replaced with constituent elements in another embodiment, or constituent elements in another embodiment may be added to constituent elements in a certain embodiment. Furthermore, some of the constituent elements in each embodiment may be altered by omission or by replacement/addition with other constituent elements. The foregoing embodiment may be modified as follows, for example.

The above embodiment is described for the case where the present disclosure is applied to both the fluid supply manifold 9 and the fluid exhaust manifold 19 among the manifolds formed mainly in the separator 3, but an embodiment is not limited to this. For example, the present disclosure may be applied to only one of the fluid supply manifold 9 and the fluid exhaust manifold 19. More specifically, the present disclosure may be applied to any manifold where the end tunnel body 15 is connected to the joint channel 13 at an acute angle via the connection portion 16 and the connection portion 16 is curved in an arc, and the shape, number, and material of manifolds are not limited.

In addition, the seal portion 8 is structured with the protrusion 8a formed in the separator 3 in the embodiment, but is not particularly limited to this. For example, the seal portion 8 may be structured with an elastic seal member held between the separators 3 and 3 or between the separator 3 and the membrane electrode structure 2.

It is understood that the foregoing description is that of the preferred embodiments of the invention and that various changes and modifications may be made thereto without departing from the spirit and scope of the invention as defined in the appended claims.

What is claimed is:

1. A fuel cell structure comprising:
a membrane electrode structure including a membrane electrode assembly and a frame member surrounding the membrane electrode assembly; and
a separator disposed between membrane electrode structures,
wherein the membrane electrode structures and separators are alternately stacked,
wherein the frame member and the separator define a communication hole which extends through the frame member and the separator in a stacking direction, allows the frame member and the separator to communicate with each other, and allows a power generation material fluid to flow through the communication hole,
wherein the fuel cell structure has a fluid channel which is provided between the membrane electrode structure and the separator and allows the power generation fluid to be supplied to the membrane electrode structure through the fluid channel,
wherein the fuel cell structure includes a seal portion which is provided around the communication hole and seals between the communication hole and the fluid channel,
wherein the fuel cell structure includes a tunnel portion which is formed in the separator, bypasses the seal portion, and allows the communication hole and the fluid channel to communicate with each other,
wherein the tunnel portion includes: tunnel bodies extending from the communication hole toward the fluid channel; a joint channel which joins ends of the tunnel bodies together so as to allow for fluid communication through the ends; and openings which allow the joint channel and the fluid channel to communicate with each other,
wherein the tunnel bodies include an end tunnel body connected to an end of the joint channel, and
wherein the end tunnel body is connected to the joint channel at an acute angle and a connection portion between the joint channel and the end tunnel body is curved in an arc.

2. The fuel cell structure according to claim 1, wherein the joint channel extends along an area to which the communication hole and the fluid channel are adjacent.

3. The fuel cell structure according to claim 1, wherein at least one of the openings is positioned apart from the connection portion of the end tunnel body.
